(19) United States
(12) Patent Application Publication
(10) Pub. No.: US 2022/0339625 A1
(43) Pub. Date: Oct. 27, 2022

(54) METHOD FOR PRODUCING AT LEAST ONE PATTERN ON A CARRIER SURFACE OF A CARRIER

(71) Applicant: cytena GmbH, Freiburg (DE)

(72) Inventors: Andre GROSS, Freiburg (DE); Ludwig GUTZWEILER, Freiburg (DE); Jonas SCHÖNDUBE, Freiburg (DE)

(21) Appl. No.: 17/765,894

(22) PCT Filed: Sep. 30, 2020
(86) PCT No.: PCT/EP2020/077360

§ 371 Date: Apr. 1, 2022

(30) Foreign Application Priority Data
Oct. 1, 2019 (LU) LU101421

(51) Int. Cl. B01L 3/00; G01N 15/14

(52) U.S. Cl. CPC B01L 3/5088; G01N 15/1434; B01L 2200/0642; B01L 2200/0668; B01L 2300/161; B01L 2400/043; G01N 2015/0065

(57) ABSTRACT

The invention relates to a method for producing at least one pattern (2) on a carrier surface (7) of a carrier (3), wherein the method comprises the following steps:
a. adding a first fluid (4) to the carrier surface (7) and
b. adding a second fluid (5), wherein the second fluid (5) is immiscible with the first fluid (4) and at least partially covers the first fluid (4) and
c. adding at least one object (6) above the carrier surface (7),
d. generating the pattern (2) by a relative movement between the object (6) and the carrier (3) in which a force is exerted on the object (6) from a force generating means (28), wherein the force transmission from the force generating means (28) on the object (6) is contactless and the pattern (2) is generated by a portion of the second fluid (15) wetting the carrier surface (7).

### CROSS-REFERENCE TO RELATED APPLICATIONS

The present application is the U.S. national phase of International Application No. PCT/EP2020/077360 filed Sep. 30, 2020, which claims priority to Luxembourg Application No. 101421 filed Oct. 1, 2019, the entire disclosures of which are incorporated herein by reference.

### FIELD OF THE DISCLOSURE

The invention relates to a method for producing at least one pattern on a carrier surface of a carrier. The invention also relates to a device for producing at least one pattern on a carrier surface of a carrier. The invention also relates to a system with such a device and at least one object and/or the carrier. Moreover, the invention relates to a computer program, a data carrier on which the computer program is stored and a data carrier signal that the computer program transmits.

### BACKGROUND OF THE DISCLOSURE

It is known from the prior art that active substances, such as monoclonal antibodies and other proteins, are produced with the aid of so-called monoclonal cell lines. These are populations of cells that are all descended from a single parent cell. The production of monoclonal cell lines is necessary because this is the only way to ensure that all cells of the population have approximately the same genome in order to produce the active ingredients with constant and reproducible quality.

In order to produce a monoclonal cell line, cells are transferred individually into the containers of a microtiter plate. The cells to be transferred are produced by genetically modifying a host cell line and isolating these modified cells. Individual cells are deposited in the microtiter plates using, for example, free-jet printing methods or pipetting. After the cells have been deposited in the respective containers of the microtitre plate, the cells can grow and may then be transferred to a bioreactor.

A device from the company iota Sciences Ltd. is known from the prior art, in which the cells are not deposited in containers of the microtitre plate, but instead in a Petri dish. Before the cells are deposited in the Petri dish, the Petri dish is placed in a holder of the device. The Petri dish contains two liquids that are immiscible with one another, wherein the second liquid is added to the Petri dish after the first liquid and completely covers the first liquid. The second liquid can be an oil such as FC-40.

A force is exerted on part of the two liquids by means of a hydrophobic pin, so that the part of the second liquid wets the bottom of the dish. In particular, the pin is moved in such a way that the part of the second liquid wetting the base of the dish forms a grid-like pattern. The part of the second liquid serves to separate the individual areas of the grid-like pattern from one another.

After the grid-like pattern has been created, a cell suspension is applied to each of the regions of the first liquid, wherein the cell suspension applied to the respective region can contain a cell. The user then manually checks for each region, for example by means of a microscope, whether the cell suspension applied has a cell in each region. If this is the case, the region containing the cell is marked manually by the user.

The aforementioned device has the disadvantage that a large number of time-consuming work steps are required in order to determine the regions containing the cell. Another disadvantage is that the pin must be replaced or cleaned before it can be used in another carrier.

### SUMMARY OF THE DISCLOSURE

The object of the invention is therefore to provide a method that enables more efficient workflows in the laboratory.

The object is achieved by a method for producing at least one pattern on a carrier surface of a carrier, wherein the method comprises the following steps:
a. adding a first fluid to the carrier surface and
b. adding a second fluid, wherein the second fluid is immiscible with the first fluid and at least partially covers the first fluid and
c. adding at least one object above the carrier surface,
d. generating the pattern by a relative movement between the object and the carrier, in which a force is exerted on the object from a force generating means, wherein the transmission of force from the force generating means (28) to the object is contactless and the pattern is generated by part of the second fluid wetting the carrier surface.

The above process steps a to d can be carried out in the order stated. At least some of the method steps a to d, in particular all method steps or method step d, as explained in detail below, can be carried out automatically, i.e. without user intervention.

In addition, the object of the invention is to disclose a device by means of which work processes in the laboratory can be carried out more efficiently.

The object is achieved by a device for receiving a carrier for receiving a first fluid and a second fluid, wherein the second fluid is immiscible with the first fluid and at least partially covers the first fluid, and for generating at least one pattern on a carrier surface of the carrier, with at least one force generating means for generating a force acting on at least one object, wherein the object can be arranged above the carrier surface and wherein the force generating means is arranged and designed in such a way that a contactless force transmission from the force generating means to the object can be implemented and wherein the pattern can be generated by a relative movement between the object and the carrier and by wetting the carrier surface with part of the second fluid.

The solution according to the invention has the advantage that efficient workflows can be implemented in the laboratory. This is possible because three fluids no longer have to be added, but only the first fluid and the second fluid. As a result, the method according to the invention is simplified compared to the methods known from the prior art. A further advantage is that a pin is no longer used, which is moved, for example, by an axis system, but instead there is contactless force transmission between the force generating means and the object. A contamination of fluids located in another carrier can be avoided in a simple manner by using another object. This eliminates the time-consuming cleaning and/or replacement of the pin. Another advantage is that due to the omission of the pin, the device does not require a spring-loaded suspension for the pin. In addition, the force of the object sliding across the carrier surface is smoother and/or more defined than when using a pin. In addition, differences in height, in particular due to different carrier shapes, no longer pose an obstacle when using the object.

The first fluid can be an, in particular aqueous, liquid and/or have a semi-solid consistency. In particular, the first fluid can be a cell suspension which promotes growth of the cells. The first fluid can have agar, a semi-solid medium or gel in order to have a firmer consistency. The second fluid can be a liquid. The second liquid can contain partially and/or fully halogenated hydrocarbons. Preferably, the second fluid can be an oil, such as a fluorinated or partially fluorinated (fluorocarbon-based) liquid, which is immiscible with the first fluid. In particular, the second fluid can be FC-40. Due to the immiscibility of the second fluid with the first fluid, the first fluid and the second fluid are arranged separately from one another and/or the second fluid is arranged on the first fluid. The second fluid can partially or completely cover the first fluid, in particular the surface of the first fluid facing the second fluid. The carrier can be a container such as a Petri dish. In this case, the carrier surface can be a surface of a container base. Alternatively, the carrier can be a plate without a side wall.

The part of the second fluid that wets the carrier surface serves to fluidically separate the pattern generated from a remaining section of the first fluid. The wetting of the carrier surface with the part of the second fluid takes place in such a way that, after wetting the part of the second fluid wetting the carrier surface, this is not pressed back into its starting position by the first fluid. The starting position is understood to be the position of the second fluid in which the second fluid does not wet the carrier surface.

The contactless transmission of force from the force generating means to the object can be realised via a force field generated by the force generating means. This means that there is no, in particular rigid and/or fixed, mechanical connection between the force generating means and the object by means of which the force generated by the force generating means is transmitted to the object. If no force generated by the force generating means acts on the object, the object can be moved relative to the force generating means and/or the carrier.

The pattern can take any shape. Thus, as will be described in more detail below, the pattern may have a closed region.

The relative movement between the carrier and the object can be achieved in that the carrier is moved and the object is stationary. Alternatively, the carrier can be stationary and the object can be moved. In addition, the carrier and the object can be moved.

The object, which does not belong to the device, may be placed above the carrier surface before or after adding the first and/or second fluid. In particular, the object can be placed on the first and/or second fluid. In this case, the object is arranged in a region which, during operation of the device, is arranged above the carrier surface of the carrier not belonging to the device, in particular in a region which extends from the carrier surface in a direction opposite to gravity. To place the object above the carrier surface, the user can drop the object into the carrier. Alternatively, the object can also be placed in a different way above the carrier surface.

The object may be configured and configured to displace the first fluid to create the pattern such that a portion of the second fluid wets the carrier surface. The part of the second fluid that wets the carrier surface can form a line, in particular a closed line. As a result, the pattern can be generated in a simple manner. The device can have a control device, by means of which the force generating means is controlled in such a way that the first fluid is displaced.

An object is understood to be a body that consists of a solid material and/or is a solid body. The object is therefore not a fluid, in particular not a gas or a liquid.

The force acting on the object can be directed in such a way that the object is moved in one direction, in particular in the direction of the carrier surface. This makes it easy to ensure that the second fluid touches the carrier surface. In addition, the force acting on the object can be directed in such a way that the object is moved in a different direction, in particular parallel to the carrier surface. This preferably takes place when the object has already been moved in the direction of the carrier surface. A resultant of the force acting on the object can have a component directed towards the carrier surface and a component acting parallel to the carrier surface. In this case, the pattern can be easily generated by moving the object parallel to the carrier surface. In addition, a contact pressure of the object on the carrier surface can be changed. The control device can correspondingly control the force generating means so that the object is moved in the direction of the carrier surface and/or parallel to the carrier surface. In addition, the contact pressure of the object on the carrier surface can be changed by means of the control device.

The force acting on the object can be created by applying a force field acting on the object. The force field can be a magnetic field and/or an electric field. In addition, the force field is generated by the force generating means. The control device can cause the object to be moved in the desired direction by controlling the force field generated by the force generating means and/or by changing the force field generated by the force generating means.

The control device can control the force generating means in such a way that the field lines of the force field, in particular a field strength of the field lines and/or an orientation of the field lines, are set in such a way that, in particular optionally, according to a first mode of operation, the object displaces the first fluid in such a way that the second fluid wets the carrier surface or that, according to a second mode of operation, the object and the carrier are moved relative to one another, but the second fluid does not wet the carrier surface. As a result, by controlling the level of the field strength, it can be achieved that the second fluid wets the carrier surface and the pattern can thus be generated.

In the first mode of operation, the field strength must be sufficiently high for the object to be moved in the direction of the carrier surface in such a way that the second fluid wets the carrier surface. The pattern can then be created by moving the object and the support relative to each other in a direction parallel to the carrier surface. In the second mode of operation, the field strength is selected in such a way that the object does not displace the first fluid in such a way that the second fluid wets the carrier surface. However, the field strength is sufficiently high that the object and the carrier are moved relative to each other within the carrier in the direction parallel to the carrier surface. The second mode of operation offers the advantage that the object can be positioned in a desired position within the carrier without creating a pattern.

The object can be moved by changing the force field, in particular a magnetic field. This can be done in that the control device correspondingly controls the field lines, in particular the field strength, of the force field generated by the force generating means. Alternatively or additionally, the object and the carrier can be moved relative to one another by moving the carrier and the force generating means relative to one another. The device can have a holder for receiving the carrier, wherein the force generating means and the holder are movable relative to one another.

In this case, the force generating means can be moved relative to the carrier and/or the holder. In this case, the force generating means is moved by a moving device of the device, while the carrier and/or the holder is arranged in a stationary manner. Alternatively or additionally, the carrier and/or the holder can be moved relative to the force generating means, while the force generating means is arranged in a stationary manner. In this case, too, the carrier and/or the holder can be moved by a moving device. An embodiment is also possible in which both the carrier and/or the holder and the force generating means can be moved relative to one another.

The moving device can have a planar runner. The planar runner can be designed in such a way that it moves along at least one predetermined path. Accordingly, the force generating means and/or the carrier and/or the holder also moves along at least one predetermined path.

The object can be magnetic or magnetizable. In particular, the object can have a permanent magnet. The object can be spherical and/or at least partially, in particular completely, hydrophobic. In particular, the object can be coated with Teflon. Such an object offers the advantage that it can be inserted into the carrier in a simple manner and is easy to handle.

In addition, the object can be configured such that it moves in a direction away from the carrier surface when a force is no longer exerted on the object or the force acting on the object is changed. This can be realised in that the object has a lower density than the first fluid and/or the second fluid. Such an object offers the advantage that, after the pattern has been generated, the object can easily be converted into an initial state in which no pattern is generated when the object moves. The density can be adjusted by the ratio of a coating material, such as Teflon, of the object to a core material of the object, such as metal.

The force generating means can generate a magnetic field. For this purpose, the force generating means can have at least one permanent magnet and/or one electromagnet. In a particularly simple embodiment, the force generating means, in particular the permanent magnet or electromagnet, can be moved relative to the carrier by means of a moving device of the device. This results in the object moving in the same direction as the force generating means. As a result, a pattern can be generated in a simple manner.

The force generating means can be arranged in such a way that the holder for receiving the carrier is located between the object and the force generating means. This offers the advantage that the force generating means can be arranged in an area of the device in which sufficient space is available. In particular, the force generating means can be arranged in a region of the device in which an optical detection device, in particular a lens of the optical detection device, is arranged.

The object can have at least two areas with different surface properties. The object can have a hydrophilic or oleophobic section and a hydrophobic or oleophilic section. The hydrophilic or oleophobic section can be arranged at one pole of the object and the hydrophobic or oleophilic section at another pole of the object. This offers the advantage that the object can be used both to create a pattern and to remove a pattern that has been created. The hydrophilic or oleophobic section can be made of metal. A surface of the object can be formed by the hydrophilic or oleophobic and the hydrophobic or oleophilic section.

The control device can control the force generating means in such a way that, in particular optionally, a force field generated by the force generating means, in particular a magnetic field, is applied to the object so that the hydrophobic or oleophilic section of the object faces the carrier surface. In this case, the hydrophobic or oleophilic section is arranged closer to the substrate than the hydrophilic or oleophobic section. Alternatively or additionally, the control device can control the force generating means such that another force field, in particular magnetic field, generated by the force generating means is applied to the object so that the hydrophilic or oleophobic section of the object faces the carrier surface. Alternatively or additionally, the control device can switch off the force field. The same force generating means can generate the force field and the other force field. For this purpose, the control device can control the force generating means in such a way that the other magnetic field is generated by reversing the polarity of the magnetic field.

The pattern can be generated when, during the relative movement between the object and the carrier, the hydrophobic or oleophilic section of the object displaces the first fluid in such a way that part of the second fluid wets the carrier surface. The pattern generated can be removed by the object if, in the relative movement between the object and the support, the hydrophilic or oleophobic portion of the object faces the carrier surface closer than the hydrophobic or oleophilic portion and/or the hydrophilic or oleophobic portion is in contact with the carrier surface. To remove the pattern, the object and the carrier move relative to each other. This can be done in a manner analogous to the generation of the pattern described above.

In displacing the first fluid, the hydrophobic or oleophilic portion of the object can be in direct contact with the first fluid. The hydrophobic section offers the advantage that the first fluid does not adhere to the object, so that the second fluid can easily wet the carrier surface.

The device can have an optical detection device for detecting the first and/or second fluid. In particular, a content of the first and/or second fluid can be detected by means of the optical detection device. The first fluid can have at least one cell and/or a particle that can be detected by the optical detection device. In particular, the optical detection device can serve to detect at least one item of cell information of a cell located in the first fluid and/or at least one item of particle information of a particle located in the first fluid.

The item of cell information and/or item of particle information can contain information about the position of the cell and/or the particle in the first fluid and/or the morphology, such as the size and/or roundness, of the cell and/or the particle and/or about the optical properties of the cell and/or the particle. The optical properties can relate to the contrast, the fluorescence and/or the granularity of the cell and/or the particle. By evaluating the item of cell information and/or item of particle information, cells or particles of relevance to the user can be identified in a simple manner and enclosed at least partially in the pattern.

The first fluid containing the cells and/or particles can be applied to the carrier surface of the carrier not belonging to the device before the pattern or patterns are generated. This is advantageous because the time-consuming production of the grid-like pattern, which is known from the prior art, is no longer necessary. It is therefore not necessary to produce a large number of patterns, but rather, certain patterns, for example those of interest to the user, can be generated. The cells and/or particles contained in the individual patterns can undergo further processing steps.

The optical detection device can have an imaging device. The imaging device can produce an image of the carrier, in particular the carrier surface. The imaging device can, for example, be a camera with optics, where the optics can be similar to a microscope. The imaging device and the object can be opposite each other with respect to the holder of the carrier. In particular, the object can be arranged above the carrier surface and the imaging device can be arranged below the carrier surface. As a result, a compact and simply constructed device is realised.

In addition, the optical detection device can have an evaluation device which determines the cell information and/or particle information on the basis of the image. The evaluation device can determine the at least one item of cell information and/or at least one item of particle information based on the image. In particular, the position of the cell and/or the particle in the first fluid can be determined by means of the evaluation device. The position of the cell and/or the particle can be determined by defining at least one optical property, in particular from the image and/or the cell and/or the particle, by means of the evaluation device. The evaluation device can be electrically connected to the control device.

The control device can cause the pattern to be generated on the basis of the data detected by the optical detection device. In addition, the shape of the patterns generated may depend on the data collected.

On the basis of the cell information and/or particle information, it can be determined where the at least one pattern should be generated. It is particularly advantageous if the position of the at least one cell or of the particle in the first fluid is determined as an item of cell information or item of particle information before the pattern is generated. This offers the advantage that it is easily known at which points on the carrier the patterns are to be generated. In particular, it is no longer necessary for a grid-shaped pattern to be generated before the first fluid is added to the carrier surface.

Alternatively or additionally, cells and/or particles that are particularly significant can be selected on the basis of the cell information and/or particle information, and only the selected cells or particles are enclosed by means of the part of the second fluid and/or only patterns are generated which enclose the selected cells and/or particles at least partially, in particular fully.

The cell information and/or particle information can be determined automatically, for example by means of the optical detection device. This reduces the workload for the user of the device because they no longer have to manually determine the position of the cells or particles themselves, for example.

In a particular embodiment, the carrier can be moved before generating the pattern based on the detected cell information and/or particle information. The carrier can be moved in such a way that the at least one cell and/or the at least one particle is moved into a new position. In particular, on the basis of the acquired item of cell information, the carrier can be shaken or vibrated and/or the first fluid can be mixed so that the at least one cell and/or that at least one particle is moved into a new position.

Before the region is generated, the carrier can be moved on the basis of the acquired cell information and/or particle information. In particular, the carrier surface can be moved in such a way that the at least one cell and/or the at least one particle are moved into a new position. The carrier can be shaken or vibrated and/or the first liquid mixed to reposition the cell or particle in the first fluid. The carrier is preferably moved when it is determined by the evaluation device that some cells and/or particles are adhering to one another and/or are arranged too close to one another. As a result, a homogeneous distribution of the cells and/or particles in the first fluid should be achieved by moving the carrier.

After the region has been generated, the remaining region of the first fluid which has no cells can be removed. As a result, only the regions containing the cells and/or particles remain on the carrier surface, so that the user can immediately see in which regions of the carrier the cells and/or particles are located. For at least partial removal of the remaining region, the device can have a removal device. The remaining region can be removed by aspirating the remaining regions and/or flushing away the remaining regions. In particular, the first fluid and the second fluid of the remaining region can be removed.

In a special embodiment, the region can be divided into at least two sub-regions. This is useful, for example, after cells have grown. By dividing the region, a part of the cells can be examined separately from the other part of the cells. The division of the region can take place in that the first fluid of the region is displaced in such a way that part of the second fluid of the region wets the carrier surface. In this case, the first fluid can be displaced by the object.

It is also advantageous if a reagent is introduced in a region having a cell. This allows cell growth within the region to be promoted or stopped in a simple manner. In particular, reagents for analysing the cell or other components of the region can also be introduced. The reagent can be added using a dispensing device. A compact device can be implemented if the removal device and the dispensing device are designed as one structural unit.

In addition, the region having a cell can be sucked out, in particular after a predetermined period of time. The sucked out cells can then be processed further, for example in a bioreactor or a microtitre plate. The at least partial suction can be carried out by the removal device. Alternatively, it is possible that a separate suction device is available.

A plurality of patterns can be generated using the method according to the invention and/or the device and/or the system according to the invention. This is useful when a plurality of cells are arranged in the first fluid. In this case, the plurality of patterns are generated in such a way that each of the plurality of patterns has at least one, in particular precisely one, single cell and/or at least one particle, in particular precisely one single particle. The plurality of patterns can be arranged adjacent to one another, that is to say separated from one another only by the part of the second fluid which wets the carrier surface. Alternatively, the plurality of patterns can be separated from one another by a remaining region which has the first fluid and which does not contain any cells or particles. In this case, the separation between the remaining region and the plurality of patterns is also achieved by means of the part of the second fluid that wets the carrier surface.

The plurality of patterns can have different cross-sections. In particular, the plurality of patterns can differ from one another in the shape and/or the size of the cross-sections. This offers the advantage that a pattern that matches the cell can be generated. This is necessary because, as previously described, different cells require different volumes, for example, in order to be able to grow. Alternatively, the plurality of patterns can have the same cross-section. The cross-section corresponds to a plane having the pattern and running parallel to the carrier surface. In addition, the plurality of patterns can differ from one another in their formation along a normal to the carrier surface.

There can be multiple objects. The multiple objects can be added to an interior space of the carrier in order to generate multiple patterns, in particular simultaneously. This allows the patterns to be generated more quickly.

The device can also have a plurality of force generating means. The force generating means can each generate a force that acts on one of the objects to generate the pattern. As a result, the simultaneous generation of a plurality of patterns as described above can be carried out in a simple manner.

The multiple force generating means may be arranged in a ring shape. In particular, the annularly arranged force generating means can enclose a part of the optical detection device, in particular a part of the imaging device, and/or the carrier. As a result, a compact device can be realised. A force field, in particular a magnetic field, can be generated by controlling the individual force generating means, as a result of which the object is moved. As a result, the object can be moved relative to the carrier without the carrier having to be moved relative to the force transmission means. In addition, the force generating means can be permanently connected to the optical detection device, so that the force generating means are also moved when the optical detection device is adjusted.

Alternatively or additionally, the device can have a force generating means array that has multiple force generating means. The plurality of force generating means can be arranged in the form of a matrix in the force generating means array. The matrix-like arrangement of the force generating means offers the advantage that the object can be moved parallel to the carrier surface by changing the force field, without the carrier and the force generating means having to be moved relative to one another. The force transmission means arranged in the form of a matrix can be permanent magnets and/or electromagnets.

The force generating means array can be designed as a Hallbach array. This offers the advantage that a force field can be generated by means of which the object is moved from a pattern generation state to an initial state. In the pattern generation state, the object is arranged such that the second fluid can wet the carrier surface. On the other hand, in the initial state, the object is arranged in such a way that the pattern cannot be generated. The Hallbach array thus has the advantage that the object no longer has to be formed in such a way that it automatically changes to the initial state after the pattern has been generated. In addition to the Hallbach array, the device can also have further force generating means, which are arranged, for example, in a ring shape, in particular around the carrier. The force generating means can be controlled in order to generate a force field which enables the object to be moved relative to the carrier.

The pattern may have a closed area. A closed area is understood to be a region on the carrier surface that is fluidically separated from the remaining section of the first fluid. In particular, the first fluid located in the region is fluidically separated from the first fluid located in the remaining section. The separation can, as described above, take place at least partially through the part of the second fluid. Thus, in addition to the second fluid, the closed area can be delimited by at least one side wall of the carrier and/or the carrier surface. The closed area can have at least one cell, in particular exactly one single cell, and/or at least one particle, in particular exactly one single particle. However, it is alternatively possible for the region to have a predefined number or no cells and/or no particles.

The closed area can have a very small volume, for example a volume between 0.5 nl (nanolitres) and 10 μl (microlitres). Regions with such a small volume enable cell growth to take place in certain cells. This arises because some cells can only grow if their concentration in the first fluid is not too low. The cells themselves have a smaller volume than the region. Likewise, the particles have a smaller volume than the region, wherein the particles can be glass or polymer beads which are introduced into the first fluid.

A device which is suitable for carrying out the method according to the invention is particularly advantageous. In addition, a system is advantageous which has the device according to the invention and at least one object, in particular a plurality of objects, and/or the carrier which receives the first fluid and the second fluid, wherein the second fluid is immiscible with the first fluid and at least partially covers the first fluid. The carrier can be received by the device.

A computer program is particularly advantageous that comprises commands that, when the program is executed by a computer, cause the computer to carry out the method according to the invention. A data carrier on which the computer program according to the invention is stored is also advantageous. In addition, a data carrier signal that transmits a computer program according to the invention is advantageous.

BRIEF DESCRIPTION OF THE DRAWING VIEWS

The subject matter of the invention is shown schematically in the figures, wherein elements that are the same or have the same effect are mostly provided with the same reference symbols. In the figures:

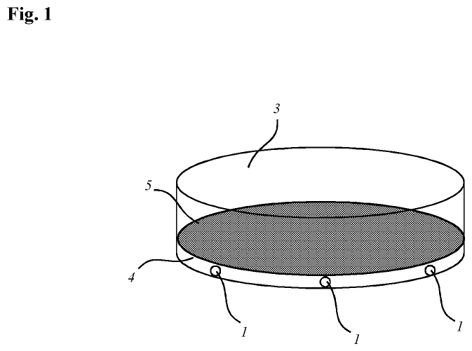

FIG. 1 shows a carrier with a first fluid and a second fluid,

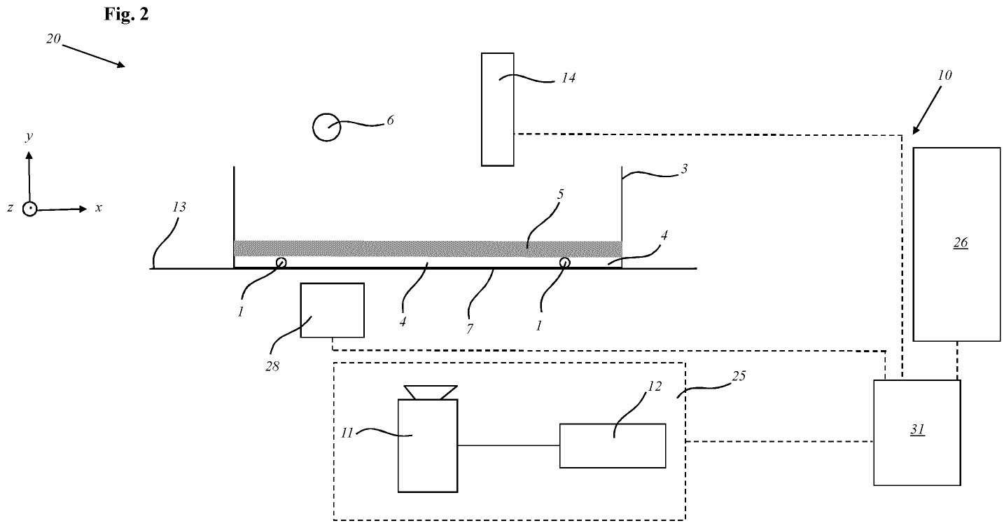

FIG. 2 shows a side view of a part of a system according to the invention according to a first embodiment before a pattern is generated,

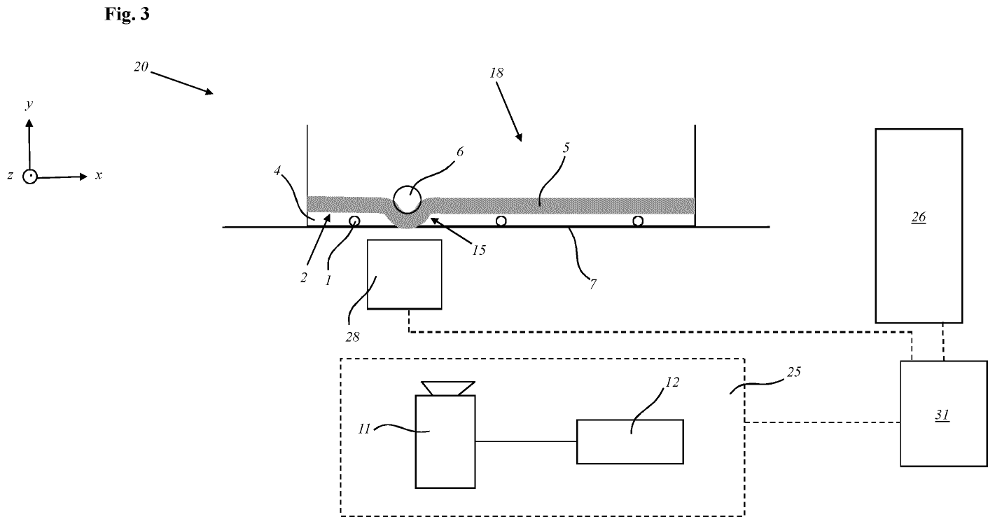

FIG. 3 shows a side view of a part of the system according to the invention according to the first embodiment, in which a pattern is generated according to a first mode of operation,

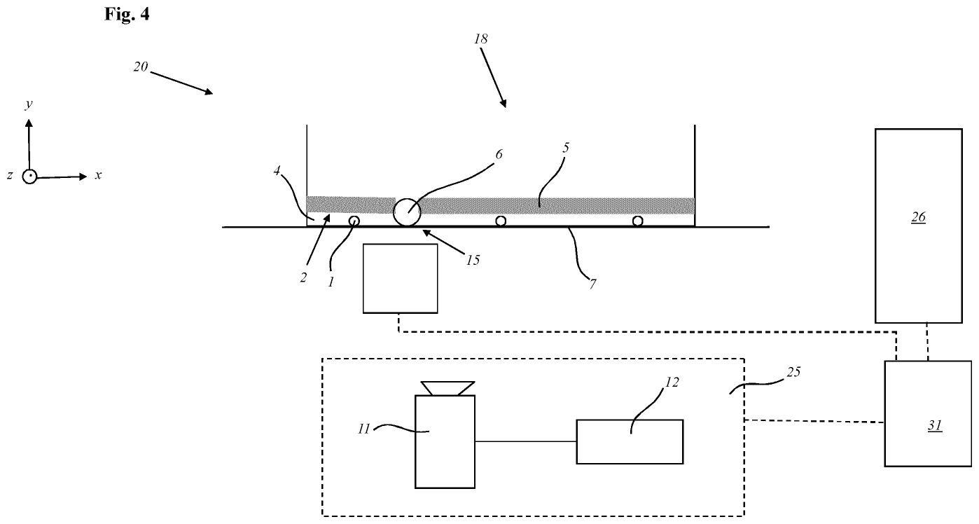

FIG. 4 shows a side view of a part of the system according to the invention according to the first embodiment, in which a pattern is generated according to a second operating mode,

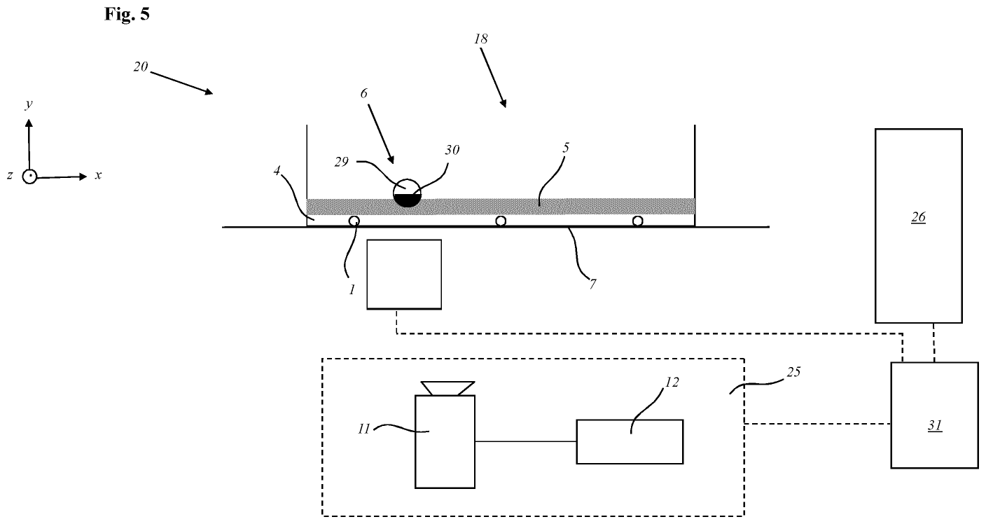

FIG. 5 shows a side view of a part of the system according to the invention according to a second embodiment, in which the object is moved relative to the carrier,

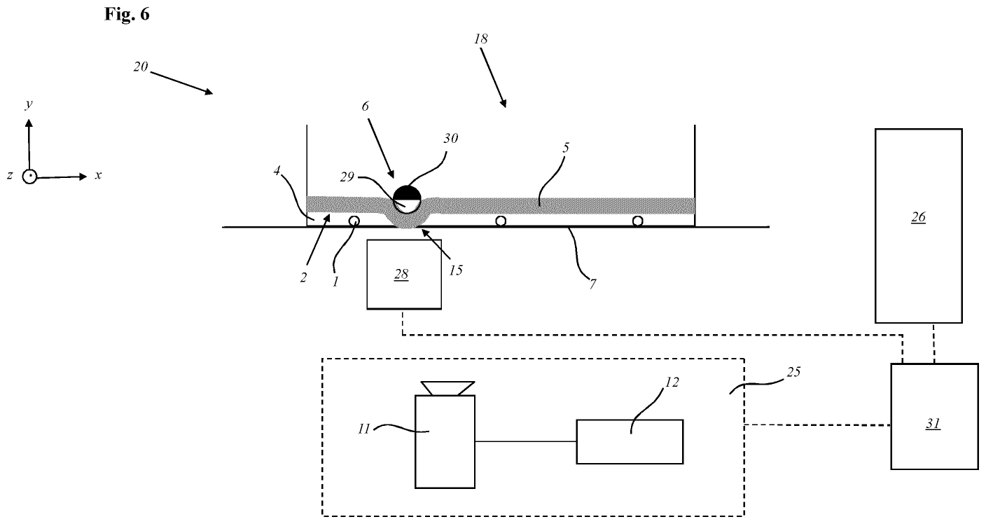

FIG. 6 shows a side view of a part of the system according to the invention according to a second embodiment, in which a pattern is generated,

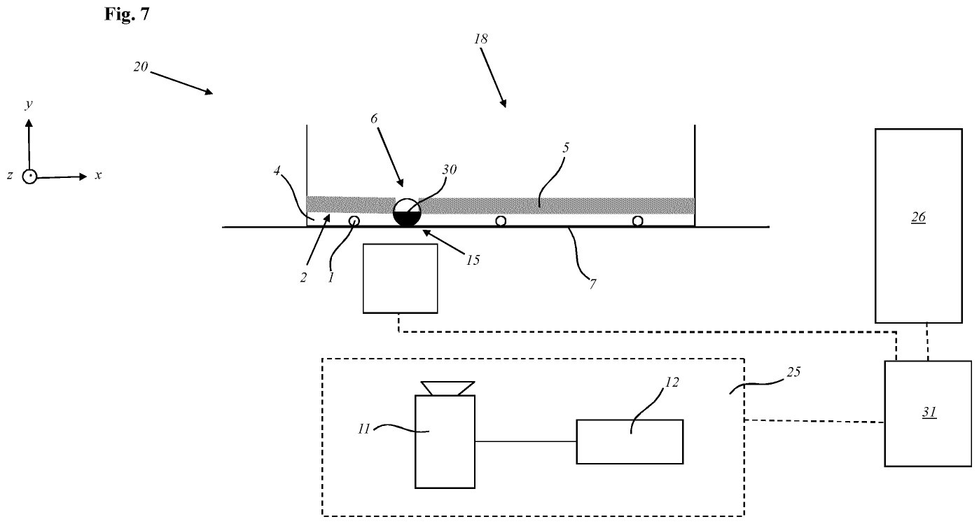

FIG. 7 shows a side view of part of the system according to the invention according to a second embodiment, in which a pattern is removed,

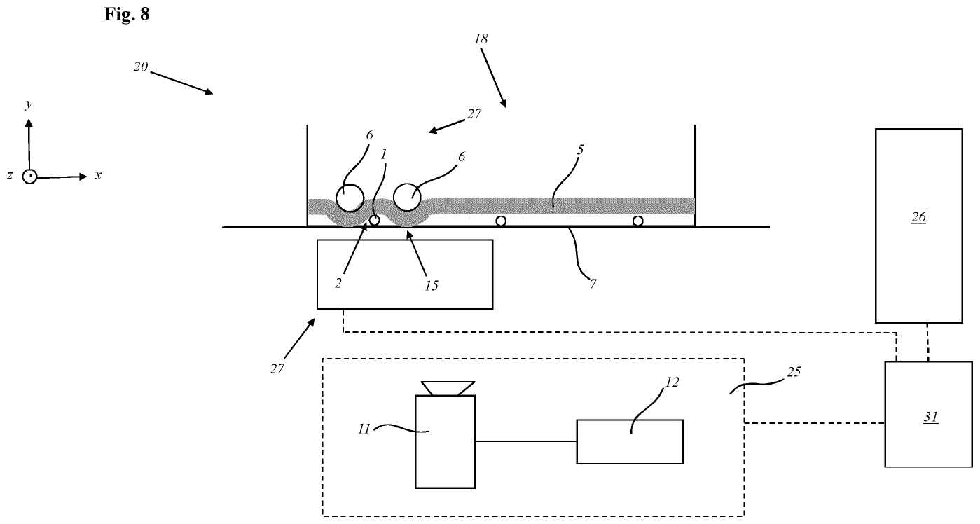

FIG. 8 shows a side view of a part of the system according to the invention according to a third embodiment, in which several objects are used to generate patterns,

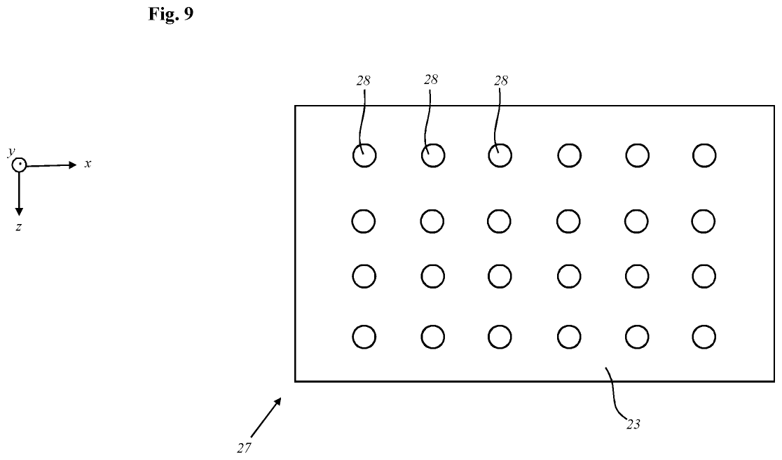

FIG. 9 shows a top view of force generating means array, and

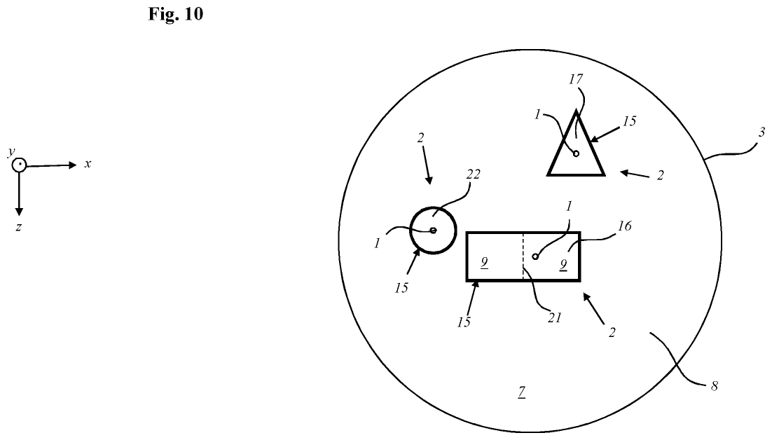

FIG. 10 shows a top view of a carrier after a plurality of patterns have been generated.

### DETAILED DESCRIPTION

FIG. 1 shows a carrier 3 which is designed as a container. The carrier 3 contains a first fluid 4 and a second fluid 5 which is immiscible with the first fluid 4. The first fluid 4 contains a plurality of cells 1. Designs are also conceivable in which the first fluid 4 alternatively or additionally contains particles. The first fluid 4 and the second fluid 5 are added to the carrier 3. The first fluid 4 can preferably be added before the second fluid 5. The second fluid 5 is arranged on the first fluid 4 and completely covers this within the carrier 3.

FIG. 2 shows a side view of part of a system 20 according to the invention before a pattern is generated. The system 20 has a device 10 and the carrier 3. In addition, the system 20 has an object 6 that is added to the carrier 3. As can be seen from FIG. 2, the carrier 3 is arranged on a holder 13 of the device 10. The object 6 is positioned above the carrier surface 7. The object 6 is positioned in such a way that it is not in contact with the first and/or second fluid 4, 5. The object 6 can have a Teflon layer and is therefore hydrophobic. In addition, the object 6 is magnetic. The object 6 is designed as a sphere in the exemplary embodiment. However, the object 6 can also have other configurations.

The device 10 has an optical detection device 25. The optical detection device 25 has an imaging device 11, by means of which an optical image of the carrier 3, in particular a carrier surface 7, can be generated. The imaging device 11 and the object 6 face each other with respect to the holder 13 of the device 10. In addition, the optical detection device 25 has an evaluation device 12. The imaging device 11 is electrically connected to the evaluation device 12. The evaluation device 12 serves to determine items of cell information, such as the position of the cells 1 located in the first fluid 4 on the carrier surface 7.

The device 10 also has a force generating means 28, by means of which a force acting on the object 6 can be generated. The force generating means 28 and the object 6 are arranged and designed in such a way that the transmission of force from the force generating means 28 to the object 6 is contactless. In this case, the force generating means 28 can have an electromagnet, by means of which an electromagnetic force is exerted on the object 6. As a result, the force is transmitted to the object 6 via a magnetic field generated by the force generating means 28. The force generating means 28 and the object 6 are opposite each other with respect to the holder 13. In particular, the carrier surface 7 is arranged between the force generating means 28 and the object 6. There is therefore no fixed and/or rigid connection between the force generating means 28 and the object 6.

The device 10 has a displacement device 26 which can move the optical detection device 25 and/or the holder 13 and/or the force generating means 28 along at least one of the directions x, y, z. In particular, the moving device 26 can move the force generating means 28 and/or the carrier 3 on the basis of the cell information determined by the evaluation device 12 in order to produce a pattern 2 described in more detail below.

The device 10 also has a removal device 14. The patterns generated and/or other sections can be sucked off by means of the removal device 14.

The device 10 also has a control device 31. The control device 31 is electrically connected to the moving device 26, the optical detection device 25, the force generating means 28 and the removal device 14.

FIG. 3 shows a side view of part of the system 20 according to the invention. In the embodiment shown in FIG. 3, the removal device 14 has been omitted in comparison with the embodiment shown in FIG. 2. In the embodiment shown in FIG. 3, a pattern 2 is generated according to a first mode of operation of the object 6. The flow of creating the pattern is explained below.

The object 6 is fed into an interior of the carrier 3 in such a way that it is in contact with the second fluid 5 and is arranged above the carrier surface 7. Before a force is exerted by the force generating means 28 on the object 6, the cell information is determined by means of the optical detection device 25. In particular, the sections of the carrier surface 7 in which the cells 1 are arranged are determined.

The control device 31 then controls the force generating means 28 in such a way that the magnetic field generated by the force generating means exerts a force on the object 6, which causes the object 6 to move in the opposite direction to the y-direction towards the carrier surface 7. The object 6 displaces the first fluid 4 in such a way that part of the second fluid 5 wets the carrier surface 7. After wetting the carrier surface 7 with a portion of the second fluid 5, the object 6 and the support are moved relative to one another in the x and/or z direction in order to produce the desired pattern. In particular, a pattern 2 is generated which at least partially, in particular completely, encloses the cell 1. The relative movement between the object 6 and the carrier 3 in the directions x and/or z is achieved in that the force generating means 28 and/or the carrier 3 are moved relative to one another. The force generating means 28 and/or the carrier 3 can be moved by the moving device 26. When the relative movement between the object 6 and the carrier 3 occurs along z and/or x directions, the first fluid 4 is also displaced by the object 6, so that the second fluid 5 wets the carrier surface 7.

In this operating mode, the object 6 presses the part of the second fluid 5 in the direction of the carrier surface 7 until the part of the second fluid 5 wets the carrier surface 7. The object 6 comes into direct contact with the carrier surface 7. As can be seen from FIG. 3, the part of the second fluid 5 is arranged between the object 6 and the carrier surface 7.

With the embodiment shown in FIG. 3, the pattern 2 is fluidically separated from a remaining section 18 by means of the part of the second fluid 15, wherein the remaining section 18 has the first fluid 4 with the plurality of cells 1. The fluidic separation takes place such that the first fluid 4 located in the region 2 is not fluidically connected to the first fluid 4 located in the remaining section 18.

FIG. 4 shows a side view of a part of the system 20 according to the invention according to the first embodiment shown in FIG. 2, wherein with the embodiment shown in FIG. 4, the removal device 14 is also omitted. In the embodiment shown in FIG. 4, a pattern 2 is generated according to a second mode of operation of the object 6. The flow of creating the pattern is explained below.

After the object 6 has been added to the interior of the carrier 3 and before a force is exerted on the object 6 by the force generating means 28, the cell information is determined by means of the optical detection device 25. In particular, the sections of the carrier surface 7 in which the cells 1 are arranged are determined.

The control device 31 then controls the force generating means 28 in such a way that a force acts on the object 6 which causes the object 6 to move in the opposite direction to they direction in the direction of the carrier surface 7. In the second operating mode, the object 6 is moved in such a way that, when it moves, it passes through the second fluid 5 and displaces the first and second fluids 4, 5. In this case, the object 6 comes into direct contact with the carrier surface 7.

After the object 6 contacts the carrier surface 7, the object 6 and the carrier 3 are moved in the direction x and/or z relative to one another in order to generate the pattern 2. In particular, a pattern is generated that encloses the cell 1 at least partially, in particular completely. During the relative movement between the object 6 and the carrier 3 along the x and/or z direction, the first fluid 4 is also displaced. Part of the second fluid 5 flows, in particular along the object, into the section of the first fluid 4 displaced by the object 6, and thus wets the carrier surface 7.

FIG. 5 shows a side view of a part of the system 20 according to the invention according to a second embodiment. The system 20 shown in FIG. 5 differs from the systems 20 shown in FIGS. 2 to 4 in the design of the object 4. The object shown in FIG. 5 has a hydrophobic section 29 and a hydrophilic section 30.

The control device 31 controls the force generating means 28 in such a way that a force directed in the direction of the carrier surface 7 acts on the object 6. However, a field strength of the force field generated by the force generating means 28 is not sufficiently high for the object 6 to be moved in the opposite direction to the direction y to such an extent that it contacts the carrier surface 7 or that part of the second fluid 5 wets the carrier surface 7. However, the field strength is sufficiently strong that the object 6 is also moved when the force generating means 28 is moved in the x and/or z direction. The object 6 can thus be moved into the desired position in the carrier 3 by moving the force generating means 28 by means of the moving device 26.

FIG. 6 shows a side view of a part of the system 20 according to the invention according to a second embodiment, in which a pattern 2 is generated. After the object 6 has been moved into the desired position according to the method described in FIG. 5, the control device 31 causes the magnetic field generated by the force generating means 28 to be reversed. This causes the object 6 to rotate. In particular, the object rotates in such a way that the hydrophobic section 29 points towards the carrier surface 7. Thus, the hydrophobic section 29 is arranged closer to the carrier surface 7 than the hydrophobic section 30.

Then, as already described in the embodiment shown in FIG. 3, the control device 31 controls the force generating means 28 such that the object 6 is moved in the direction counter toy, so that the part of the second fluid 15 wets the carrier surface 7. The object 6 and the carrier 3 are then moved relative to one another in the x and/or z direction in order to produce the pattern 2.

FIG. 7 shows a side view of a part of the system 20 according to the invention according to the second embodiment, in which a pattern which has already been generated is removed. The control device 31 controls the force generating means 28 such that a magnetic field causing the hydrophilic portion 30 of the object 6 to face toward the carrier surface 7 is generated. Thus, the hydrophilic section 30 is arranged closer to the carrier surface 7 than the hydrophobic section 29. The control device 31 then controls the force generating means 28 in such a way that a force acts on the object 6 such that the object 6 is moved in the direction of the carrier surface 7 until the object 6 contacts the carrier surface 7. The object 6 and the carrier 3 are then moved relative to one another in the x and/or z direction in order to remove the pattern 2. The part of the second fluid 15 that wets the carrier surface 7 dissolves when the hydrophilic section 30 of the object 6 comes into contact with the wetted point of the carrier surface 7.

FIG. 8 shows a side view of a part of the system 20 according to the invention according to a third embodiment. The third embodiment differs from the first and second embodiment in that a plurality of objects 6 have been added to the carrier 3. Another difference is that there is a force generating means array 27 in the device 10 according to the third embodiment. The force generating means array 27 has a plurality of force generating means 28 which are arranged in a matrix on a plate 23 of the force generating means array 27. The force generating means array 27 makes it possible for a plurality of objects 6 to be controlled independently of one another, in particular simultaneously. For this purpose, the control device 31 controls the individual force generating means 28 in such a way that different forces can act on the objects in different directions.

The control device 31 can control the force generating means array 27 such that the objects 6 are moved within the carrier 3. In particular, the control device 31 can control the generated magnetic fields in such a way that the objects are moved, in particular in the x and/or z direction. In this embodiment, it is not necessary for the carrier 3 and the force generating means 27 to be moved relative to one another in order to move the object 6, in particular in order to generate the pattern 2.

FIG. 9 shows a top view of the force generating means array 27. The matrix-like arrangement of the force generating means 28 on the plate 23 can be seen from the top view. The individual force generating means 28 can each be designed as an electromagnet and have a coil and a core.

FIG. 10 shows a top view of a carrier 3 after a plurality of patterns 2, namely the first pattern 22, the second pattern 16 and the third pattern 17, have been generated. The arrangement of the cells 1 in the carrier 3 shown in FIG. 6 differs from the arrangement of the cells 1 in the carrier 3 shown in FIGS. 1 to 8. The three patterns 2 are designed as closed areas.

As can be seen from FIG. 10, the three patterns 2 differ in their cross-section. In addition, the three patterns 2 differ from one another in their design and volume. The first pattern 22 has a circular shape, the second pattern 16 has a rectangular shape and the third pattern 17 has a triangular shape. A remaining region 8 was removed by means of the removal device 14.

The second pattern 16 can be divided into two sub-regions 9. This can occur when the object 6 displaces the first fluid 4 of the second pattern 16. As a result, another part of the second fluid 15 wets the carrier surface 7. The other part of the second fluid 15 separating the two sub-regions 9 is shown in FIG. 10 by a dashed line.

The patterns 2 shown in FIG. 10 can be generated using one of the methods described above.

### LIST OF REFERENCE NUMERALS

1 Cell

2 Pattern

3 Carrier

4 First fluid

5 Second fluid

6 Object

7 Carrier surface

8 Remaining region having no cells

9 Sub-region

10 Device

11 Imaging device

12 Evaluation device

13 Holder

14 Removal device

15 Part of the second fluid

16 Second pattern

17 Third pattern

18 Remaining section

20 System

21 Fourth part of the second fluid

22 First pattern

23 Plate

25 Optical detection device

26 Moving device

27 Force generating means array

28 Force generating means

29 Hydrophobic section of the object

30 Hydrophilic section of the object

31 Control device

x, y, z Direction

What is claimed is:

1. A method for producing at least one pattern (2) on a carrier surface (7) of a carrier (3), wherein the method comprises the following steps:
a. adding a first fluid (4) to the carrier surface (7),
b. adding a second fluid (5), wherein the second fluid (5) is immiscible with the first fluid (4) and at least partially covers the first fluid (4),
c. adding at least one object (6) above the carrier surface, and
d. generating the pattern (2) by a relative movement between the object (6) and the carrier (3) in which a force is exerted on the object (6) from a force generating means (28), wherein the force transmission from the force generating means (28) on the object (6) is contactless and the pattern (2) is generated by a portion of the second fluid (15) wetting the carrier surface (7).

2. The method according to claim 1, characterised in that the object (6) and the carrier (3) are moved relative to one another in such a way that the first fluid is displaced in such a way that the part of the second fluid (15) wets the carrier surface (7).

3. The method according to claim 1, characterised in that
a. the force acting on the object (6) is directed in such a way that the object (6) is moved in one direction, in particular in the direction of the carrier surface (7), and/or a contact pressure of the object (6) on the carrier surface is changed, and/or that
b. the force acting on the object (6) is directed in such a way that the object (6) is moved in a different direction, in particular parallel to the carrier surface (7).

4. The method according to claim 1, characterised in that the force acting on the object (6) is generated by applying a force field, in particular a magnetic field, and the object (6) is moved by changing the force field, in particular the magnetic field.

5.-10. (canceled)

11. The method according to claim 1, characterised in that the object (6) has a hydrophobic or oleophilic section (29) and a hydrophilic or oleophobic section (30), and in that
a. the pattern (2) is generated when, during the relative movement between the object (6) and the carrier (3), the hydrophobic or oleophilic section (29) of the object (6) displaces the first fluid (4) in such a way that the part of the second fluid (15) wets the carrier surface (7), and/or that
b. a pattern (2) generated by the object (6) is removed if, during the relative movement between the object (6) and the carrier (3), the hydrophilic or oleophobic section (30) of the object (6) faces closer towards the carrier surface (7) than the hydrophobic or oleophilic section (29) and/or the hydrophilic or oleophobic section (30) is in contact with the carrier surface (7).

12.-13. (canceled)

14. The method according to any claim 1, characterised in that the pattern (2) has a closed area which has at least one cell (1) and/or at least one particle.

15. (canceled)

16. The method according to claim 1, characterised in that
a. at least one remaining region (8) having no cell (1) is removed, and/or in that
b. a reagent is introduced into the region (2) having in particular a cell (1) or a particle, and/or in that
c. the region (2) having in particular a cell (1) or a particle is at least partially sucked out or filled up.

17. The method according to any claim 1, characterised in that
a. a plurality of patterns (2) are generated, wherein the patterns (2) have the same or different cross-sections, and/or in that
b. a plurality of patterns (2) are generated which differ from one another in their formation along a normal to the carrier surface (7).

18. The method according to claim 1, characterised in that a plurality of objects (6) are added to the interior of the carrier (3), which generate a plurality of patterns, in particular simultaneously.

19.-20. (canceled)

21. A device (10) for receiving a carrier for receiving a first fluid (4) and a second fluid (5), wherein the second fluid (5) is immiscible with the first fluid (4) and at least partially covers the first fluid (4), and for generating at least one pattern (2) on a carrier surface (7) of the carrier (3), with at least one force generating means (28) for generating a force acting on at least one object (6), wherein the object (6) can be arranged above the carrier surface (7) and wherein the force generating means (28) is arranged and designed in such a way that a contactless force transmission can be implemented from the force generating means (28) to the object (6) and wherein the pattern (2) can be generated by a relative movement between the object (6) and the carrier and by wetting the carrier surface (7) with part of the second fluid (15).

22. (canceled)

23. The device (10) according to claim 21, characterised in that the device (10) has a control device (31) which causes a relative movement between the object (6) and the carrier (3) by controlling a force field generated by the force generating means (28) and/or by changing a force field generated by the force generating means (28), and the control device (31) controls the force generating means (28) in such a way that the force which can be exerted by the force generating means (28) on the object (6) is directed in such a way that
a. the object (6) is moved in one direction, in particular in the direction of the carrier surface (7), and/or that
b. the object (6) is moved in a different direction, in particular parallel to the carrier surface (7).

24. (canceled)

25. The device (10) according to claim 21, characterised in that the device (10) has a plurality of force generating means (28) which are arranged in the form of a matrix or ring.

26. The device (10) according to claim 21, characterised in that the device (10) has a holder (13) for receiving the carrier (3), wherein
a. the force generating means can be arranged in such a way that the holder (13) is located between the object (6) and the force generating means (28), and/or that
b. the force generating means (28) and the holder (13) are movable relative to each other.

27. (canceled)

28. The device (10) according to claim 21, characterised by an optical detection device (25) for detecting at least one item of cell information of a cell located in the first fluid (4) and/or at least one piece of particle information of a particle located in the first fluid (4).

29. (canceled)

30. The device (10) according to claim 28, characterised in that
a. the optical detection device (25) has an imaging device (11) for producing an image of the carrier surface (7), or in that
b. the optical detection device (25) has an imaging device (11) for producing an image of the carrier surface (7) and an evaluation device (12), which determines the item of cell information and/or item of particle information on the basis of the image.

31. The device (10) according to claim 21, characterised by
a. a removal device (14) for removing the remaining region (8) of the first fluid (4) having no cells, or by
b. a removal device (14) for at least partially sucking off a remaining region (8) which has no cells of the first fluid (4).

32.-33. (canceled)

34. The device (10) according to claim 31, characterised in that
a. the object (6) is magnetic or magnetisable, or that
b. the object (6) has a permanent magnet.

35. The device (10) according to claim 31, characterised in that the object (6) has a lower density than the first fluid (4) and/or the second fluid (5).

36. The device (10) according to claim 31, characterised in that the object (6) has a hydrophilic or oleophobic section (30) and a hydrophobic or oleophilic section (29).

37. (canceled)

38. A non-transitory computer-readable storage medium comprising commands that, when executed by a computer, cause the computer to carry out the method of claim 1.

39.-40. (canceled)
